(19) United States
(12) Patent Application Publication
(10) Pub. No.: US 2021/0242999 A1
(43) Pub. Date: Aug. 5, 2021

(54) METHOD AND SYSTEM FOR NOVEL SIGNALING SCHEMES FOR 5G NEW RADIO

(71) Applicants: Centre of Excellence in Wireless Technology, Chennai (IN); Indian Institute of Technology Madras (IIT Madras), Chennai (IN)

(72) Inventors: Dhivagar Baskaran, Chennai (IN); Sunil Kaimalettu, Chennai (IN); Thirunageswaram Ramachandran Ramya, Chennai (IN); Pardhasarathy Jyothi, Chennai (IN); Sri Harsha Venkata Paka, Chennai (IN); Saraswati Kumari, Chennai (IN); Abhijeet Masal, Chennai (IN); Chandrasekaran Mohandoss, Chennai (IN); Sree Charan Teja Reddy Budama, Chennai (IN); Priyanka Dey, Chennai (IN); Klutto Milleth Jeniston Deviraj, Chennai (IN); Bhaskar Ramamurthi, Chennai (IN)

(21) Appl. No.: 17/053,049

(22) PCT Filed: May 7, 2019
(86) PCT No.: PCT/IN2019/050360

§ 371 Date: Nov. 4, 2020

(30) Foreign Application Priority Data
May 7, 2018 (IN) 201841017169
Mar. 6, 2019 (IN) 201941008781

(51) Int. Cl. H04L 5/00; H04W 72/04; H04L 27/26

(52) U.S. Cl. CPC H04L 5/0094; H04W 72/048; H04L 27/261; H04L 27/2636; H04L 5/0048; H04L 5/001

(57) ABSTRACT

Accordingly, embodiments herein disclose a method and system for novel signaling schemes for 5G New Radio. The method includes determining a subcarrier spacing (SCS) of a Bandwidth Part (BWP), a size of the BWP, and a location of the BWP. Further, the method includes generating a BWP configuration comprising the SCS of the BWP, the size the BWP, and the location of the BWP. Further, the method includes indicating the BWP configuration to a User Equipment.

The present invention relates to wireless communication and more particularly relates to a method and system for novel signaling schemes for 5^{th} Generation (5G) New Radio (NR) access technology. The present application is based on, and claims priority from PCT application PCT/IN2019/050360 filed on 7^{th} may 2019, and Indian Application Number 201841017169 filed on 7^{th} May, 2018 and Indian Application Number 201941008781 filed on 6^{th} March, 2019 the disclosure of which is hereby incorporated by reference herein.

### FIELD OF INVENTION

### Background of Invention

New Radio (NR) access technology for the 5th generation (5G) broadband system is designed to support multiple technologies/services under a same network. A major introduction in 5G New Radio (NR) access technology is the millimeter wave (mmWave) band operation, mainly due to availability of a vast amount of spectrum. This paves the way for multiple new technologies and schemes to be included in NR access technologies like wideband (WB) operations under a single component carrier, use of antenna array systems (AAS) supporting full dimensional—multiple input multiple output (FD-MIMO) techniques. To support these new techniques, modifications are required to be made in NR, like the concept of bandwidth part (BWP) based operation, beam based operations and new reference signal transmissions.

Thus, it is desired to address the above mentioned disadvantages or other shortcomings or at least provide a useful alternative.

### OBJECT OF INVENTION

The principal object of the embodiments herein is to provide a method and system for novel signaling schemes for SGNR access technology.

Another object of the embodiments is to provide a method for managing interference in an Orthogonal Frequency Division Multiplexing (OFDM) system.

Another object of the embodiments is to provide a method for determining a phase-noise compensation tracking reference signal (PTRS) pattern in discrete Fourier transform spread orthogonal frequency division multiplexing (DFT-s-OFDM) system.

Another object of the embodiments is to provide a method for optimizing a Channel State Information (CSI) acquisition in an OFDM system.

### SUMMARY

Accordingly, the invention provides a method for managing interference in an OFDM system. The method includes determining a subcarrier spacing (SCS) of a BWP, a size of the BWP, and a location of the BWP. The method further includes generating a BWP configuration comprising the SCS of the BWP, the size the BWP, and the location of the BWP. The method further includes indicating the BWP configuration to a User Equipment.

In an embodiment, the BWP configuration is indicated to the user equipment (UE) during an initial access or semi-statically using a higher layer signaling. The base station (BS) indicates the BWP configuration to the UE after receiving capability information from the UE indicating a capability of the UE to receive a type of BWP configuration, and the BS sending to the UE the type of BWP configuration used by RRC signalling.

In an embodiment, the location of the BWP comprises an offset of a starting resource block (RB) of the BWP with respect to a zeroth RB of a wideband component carrier (WB-CC).

In an embodiment, defining the size of the BWP includes determining whether the size of the BWP is a multiple of a Resource Block Group (RBG) from a set of RBGs. The defining further includes performing either: defining the size of the BWP comprises of a first signal and a second signal when the size of the BWP does not have to be the multiple of the RBG from the set of RBGs; or defining the size of the BWP comprises of the first signal when the size of the BWP does have to be the multiple of the RBG from the set of RBGs.

In an embodiment, determining the first signal includes defining a maximum RBG corresponding to a largest BWP in a WB-CC, and determining the first signal based on a function of the maximum RBG, a maximum bitmap size, and a maximum value for the first signal.

In an embodiment, the first signal is indicated to the UE by determining whether the RBG for the BWP is known or not known to the UE in the WB-CC, and performing either indicating the first signal to the UE as a number of RBs in the BWP or as an index of a pre-defined set comprising all possible values of the first signal, when the RBG for the BWP is not known to the UE in the WB-CC or indicating an index of a pre-defined set of values of the first signal to be derived by the UE, when the RBG for the BWP is known to the UE in the WB-CC.

In an embodiment, the second signal are indicated to the UE by determining whether the RBG for the BWP information is known or not known to the UE in the WB-CC, and performing either indicating the second signal to the UE as a number of RBs in the BWP or as an index of a pre-defined set comprising all possible values of the second signal, when the RBG for the BWP information is not known to the UE in the WB-CC or indicating an index of a pre-defined set of values of the second signal to be derived by the UE, when the RBG for the BWP information at the UE in the WB-CC.

In an embodiment, the location of the BWP is determined based on a multiple of a maximum RBG corresponding to a largest BWP in a WB-CC.

In an embodiment, the location of the BWP is indicated to the UE by determining whether the RBG for the BWP information is known or not known to the UE in the WB-CC, and performing either indicating the location of the BWP to the UE as the number of RBs in the WB-CC or as an index of a pre-defined set comprising all possible values of location of the BWP, when the RBG for the BWP information is not known to the UE in the WB-CC or indicating an index of a pre-defined set of location of the BWP to be derived by the UE, when the RBG for the BWP information is known to the UE in the WB-CC.

In an embodiment, further the method includes determining a bitmap for the BWP configuration to identify the location of the BWP and a size of the BWP, and wherein the size of the bitmap is a combination of a number of bits required to represent the location of the BWP and a number of bits required to represent the size of the BWP and indicating the bitmap to the UE.

In an embodiment, the method further includes determining a bitmap for the BWP configuration to identify a RBG, the location of the BWP and a size of the BWP, wherein the size of the bitmap is a combination of a number of bits required to represent the RBG and the number of bits required to represent the location of the BWP and a number of bits required to represent the size of the BWP, and indicating the bitmap to the UE.

Accordingly, the embodiments herein provide a Base Station for managing interference OFDM system. The Base Station includes BWP configuration engine coupled with a processor and a memory. The BWP configuration engine is configured to determine a SCS of a BWP, a size of the BWP, and a location of the BWP. Further, the BWP configuration engine is configured to generate a BWP configuration comprising the SCS of the BWP, the size the BWP, and the location of the BWP. Further, the BWP configuration engine is configured to indicate the BWP configuration to a User Equipment.

Accordingly the invention provides a method for determining a PTRS pattern in DFT-s-OFDM system includes determining a number of chunks based on a Power Spectral Density (PSD) of a Phase Noise (PN) samples, determining a number of samples in each of the chunks based on at least one signal quality metric, and determining the PTRS pattern based on the number of chunks and the number of samples.

In an embodiment, determining the number of chunks based on the PSD of the PN samples includes obtaining the PSD of the PN samples, determining an auto-correlation factor from the PSD by performing an Inverse Fast Fourier Transform (IFFT) of the PSD, determining a maximum time lag between the PN samples at which the auto-correlation factor meets an auto-correlation threshold, and determining the number of chunks based on the maximum time lag between the PN samples and a OFDM symbol duration for a SCS.

In an embodiment, determining the number of samples in each of the chunks based on one of the signal-to-interference-plus-noise ratio (SINR), the channel quality indicator (CQI) and the modulation coding scheme (MCS) includes determining whether the at least one signal quality metric meets at least one quality threshold, and determining the number of samples in each of the chunks by selecting the number of samples for each chunk corresponding to the at least one quality threshold.

In an embodiment, further the method includes determining a PTRS overhead based on the number of chunks, the number of samples in each of the chunks, and a number of scheduled Resource Blocks (RB), determining whether the PTRS overhead meets a PTRS overhead threshold, and performing either fixing the PTRS pattern when the PTRS overhead meets the PTRS overhead threshold or reducing an auto-correlation threshold when the PTRS overhead does not meet the PTRS overhead threshold.

In an embodiment, reducing an auto-correlation threshold when the PTRS overhead does not meet the PTRS overhead threshold includes determining whether the auto-correlation threshold is less than a predefined value, and performing either fixing the PTRS pattern based on scheduled RBs when the auto-correlation threshold is less than the predefined value or reducing the auto-correlation threshold and re-determine the PTRS pattern when the auto-correlation threshold is not less than the predefined value.

In an embodiment, the signal quality metric is derived based on at least one of a SINR, a Channel Quality Indicator (CQI), a Reference signal received power (RSRP), a Reference Signal Received Quality (RSRQ) and a Modulation Coding Scheme (MCS).

In an embodiment, the BS receives a capability information of UE indicating at least one of a presence of a default table of thresholds on the scheduled bandwidth, for the PTRS chunk pattern selection in the DFT-s-OFDM system, using non-critical extension bits, a capability of the UE to switch the PTRS chunk pattern selection based on the at least one signal quality metric, differential value of threshold values of the scheduled bandwidth using non-critical extension bits, when RRC signaling is used to indicate the threshold values of the scheduled bandwidth, and a capability to use a PTRS density table using non-critical extension bits.

In an embodiment, the BS sends a RRC message to UE indicating at least one of a presence of a default table of thresholds on scheduled bandwidth, for the PTRS chunk pattern selection in the DFT-s-OFDM system, using non-critical extension bits, a capability of the BS to switch or use the PTRS chunk pattern based on the at least one signal quality metric using non-critical extension bits, differential value of threshold values of the scheduled bandwidth, when RRC signaling is used to indicate the threshold values of the scheduled bandwidth using non-critical extension bits, and a capability to use a PTRS density table using non-critical extension bits.

Accordingly, the embodiments herein provide the DFT-s-OFDM system for determining a PTRS pattern in DFT-s-OFDM system. The DFT-s-OFDM system includes a PTRS engine coupled with a processor and a memory. The PTRS engine is configured to determine a number of chunks based on a PSD of a PN samples. Further, the PTRS engine is configured to determine a number of samples in each of the chunks based on at least one signal quality metric. Further, the PTRS engine is configured to determine the PTRS pattern based on the number of chunks and the number of samples.

Accordingly the invention provides a method for optimizing a CSI acquisition in an OFDM system includes receiving a capability information of a User Equipment (UE), determining a time unit based on at least one of a capability of the UE, a channel condition of a link between the BS and the UE, and a SCS, wherein the time unit indicates a delay for updating a precoder used for SRS transmission from a Channel State Information Reference Signal (CSI-RS) associated with a Sounding Reference Signal (SRS) transmission at the UE, indicating the time unit to the UE in one of a one-bit Radio Resource Control (RRC) Information Element (IE) and an n-bit RRC IE, and configuring and transmitting the CSI-RS to the UE for a SRS precoder selection based on the time unit and a UE timing advance.

In an embodiment, the time unit is indicated in one of a one-bit Radio Resource Control (RRC) Information Element (IE) and an n-bit RRC IE.

In an embodiment, the n-bit RRC IE comprises the time unit and corresponding offset of a number of OFDM symbols.

In an embodiment, the capability information send by the UE to the BS is one of the one bit IE and the n-bit IE.

In an embodiment, the n-bit IE indicate an offset of number of OFDM symbols corresponding to a minimum time unit required for UE processing.

In an embodiment, the method comprises indicating, by the BS, one of a capability of enhancement to the SRS precoder updation with a channel dependent delay between the SRS transmission and the CSI-RS to the UE using non-critical extension bit, and an actual delay in signalling to the UE using non-critical extension bit.

Accordingly, the embodiments herein provide the Base Station for optimizing a CSI acquisition in an OFDM system. The Base Station includes a SRS precoder engine coupled with a processor and a memory. The SRS precoder engine is configured to receiving a capability information of a User Equipment (UE). Further, the SRS precoder engine is configured to determining a time unit based on at least one of a capability of the UE, a channel condition of a link between the BS and the UE, and a SCS, wherein the time unit indicates a delay for updating a precoder used for SRS transmission from a CSI-RS associated with a SRS transmission at the UE. Further, the SRS precoder engine is configured to indicating the time unit to the UE. Further, the SRS precoder engine is configured to configuring and transmitting the CSI-RS to the UE for a SRS precoder selection based on the time unit and a UE timing advance.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1A is an illustration of multiple BWPs configured in a WB-CC, according to embodiments as disclosed herein;

FIG. 1B is an illustration of BWP configuration, according to embodiments as disclosed herein;

FIG. 1C illustrates a block diagram of a base station for managing interference in an OFDM system, according to an embodiment as disclosed herein;

FIG. 1D is a flow diagram illustrating a method for managing interference in an OFDM system, according to an embodiment as disclosed herein;

FIG. 1E is a flow diagram illustrating a method for defining the size of the BWP, according to an embodiment as disclosed herein;

FIG. 1F is a flow diagram illustrating a method for the location of the BWP is indicated to the UE, according to an embodiment as disclosed herein;

FIG. 2A is an illustration of CSI-RS aided precoded SRS transmission, according to embodiments as disclosed herein;

FIG. 2B illustrates a block diagram of a base station for optimizing a CSI acquisition in an OFDM system, according to embodiments as disclosed herein;

FIG. 2C is a flow diagram illustrating a method for optimizing a CSI acquisition in an OFDM system, according to embodiments as disclosed herein;

FIG. 3A is a block diagram of DFT-s-OFDM system with pre-DFT PTRS insertion, according to embodiments as disclosed herein;

FIG. 3B is an illustration of two example PTRS chunk patterns, according to embodiments as disclosed herein;

FIG. 3C illustrates a block diagram of (DFT-s-OFDM) system for determining a PTRS pattern, according to embodiments as disclosed herein;

FIG. 3D is a flow diagram illustrating a method for determining a PTRS pattern in DFT-s-OFDM system, according to embodiments as disclosed herein;

FIG. 3E is a flow diagram illustrating a method for determining the number of chunks based on the PSD of the PN samples, according to embodiments as disclosed herein; and

FIG. 3F is a flow diagram illustrating a method for determining the number of samples in each of the chunks based on one of the SINR, the CQI and the MCS, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly the invention provides a method for managing interference in an OFDM system includes determining a SCS of a BWP, a size of the BWP, and a location of the BWP, generating a BWP configuration comprising the SCS of the BWP, the size the BWP, and the location of the BWP, and indicating the BWP configuration to a User Equipment.

Accordingly the invention provides a method for optimizing a CSI acquisition in an OFDM system includes receiving a capability information of a User Equipment (UE), determining a time unit based on at least one of a capability of the UE, a channel condition of a link between the BS and the UE, and a SCS, wherein the time unit indicates a delay for updating a precoder used for SRS transmission from a CSI-RS associated with a SRS transmission at the UE, indicating the time unit to the UE, and configuring and transmitting the CSI-RS to the UE for a SRS precoder selection based on the time unit and a UE timing advance.

Accordingly the invention provides a method for determining a PTRS pattern in DFT-s-OFDM system includes determining a number of chunks based on a PSD of a PN samples, determining a number of samples in each of the chunks based on at least one signal quality metric, and determining the PTRS pattern based on the number of chunks and the number of samples.

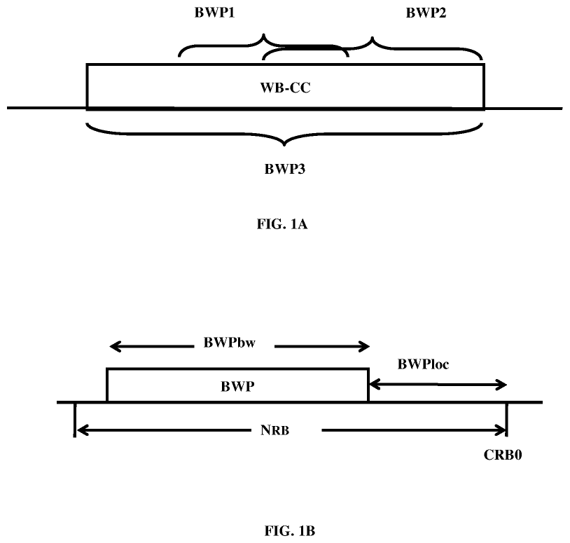

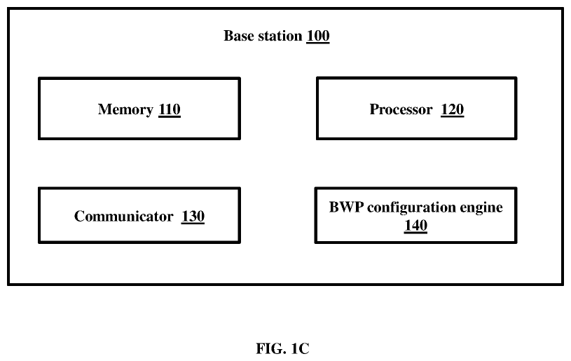

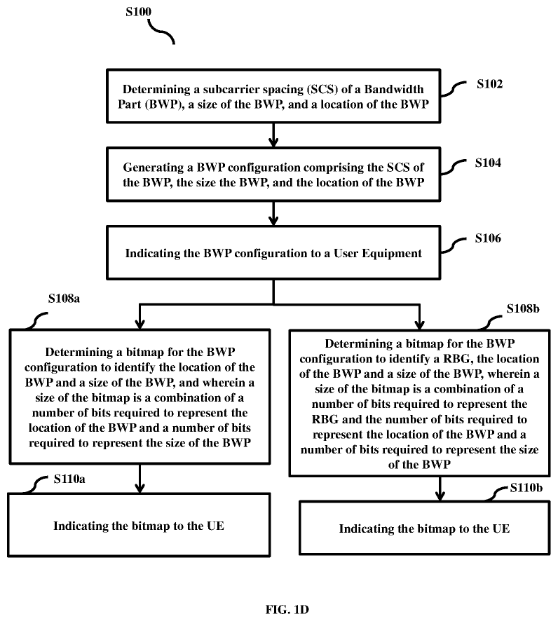

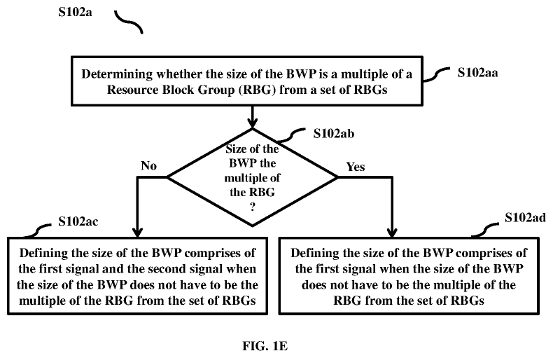

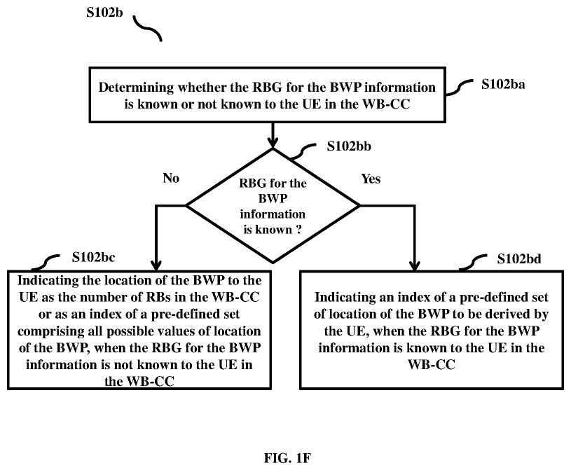

Referring now to the drawings, and more particularly to FIGS. 1A through 3F there are shown preferred embodiments.

FIG. 1A is an illustration of multiple BWPs configured in a WB-CC, according to embodiments as disclosed herein. In BWP configuration, the current design of NR targets up to 400 MHz under a single component carrier (CC), but the User Equipment (UE) can operate over a selected portion of the WB depending upon the UE's capability. To also support such UEs which are incapable of supporting the WB operation, NR has defined the concept of BWP. As the name implicates, a BWP is a part of the WB-CC over which a UE operates.

A BWP is configured for each UE during initial access procedures and can be changed using higher layer or Layer 1 signaling. Each UE can also be configured with multiple BWPs and each BWP can have its own SCS and cyclic prefix (CP) duration. Here the SCS could mean the numerology of the BWP. Consider a BWP whose size is to be determined as per the UE capability. Defining the numerology of the BWP as BWP_{μ}, the maximum number of resource blocks (RBs) in the wideband carrier is considered as N_{RB} using the numerologyBWP_{μ}. Now the RBs are respectively indexed as 0 to). Here an RB is defined as a set of consecutive subcarriers of an OFDM symbol. Now a BWP configuration is defined using the parameters BWP_{μ}, BWP_{bw} and BWP_{loc}. This is indicated to a UE during initial access or semi-statically using higher layer signaling. A BWP is defined from a UE's perspective, hence there can be multiple BWPs sharing the same resource.

FIG. 1B is an illustration of BWP configuration, according to embodiments as disclosed herein. In an embodiment, the BWP configuration parameters can be summarized as:
a. BWP_{μ}—SCS of the BWP
b. BWP_{bw}—Size of the BWP in terms of BWP_{μ}, with a resolution on 1 RB.
c. BWP_{loc}—Offset of the starting RB of the BWP with respect to zeroth RB (CRB0) of the WB-CC, in terms of the number of RBs with respect to BWP_{μ}.

For determining BWP size, a scheduling of the WB-CC is done by the base station, which indicates the scheduling decision to the user equipment (UE). Scheduling is done in terms of RBG, which is a collection of contiguous RBs, in the frequency domain. RBG_{bwp} is defined as the number of RBs in an RBG for a given BWP. After scheduling, the scheduled RBGs are indicated to the UE using a RBG bitmap or using a start and length indicator value (SLIV).

The method is used to effectively select the BWP_{bw}, BWP_{loc} and the RBG_{bwp} for each BWP, to avoid wastage of resources due to the limitation of RBG based scheduling and signaling through RBG bitmap. Defining the size for the frequency allocation bitmap in the downlink control information (DCI) as BMP_{bwp} for Type0 based resource allocation, the following formula is defined to determine optimal BWP sizes for any UE as shown below.

The BWP_{bw} value given to a user, is a combination of two parameters
a. S₁—value which is a multiple of RBG_{bwp}.
b. S₂—residual RBs which is from a set {0: (RBG_{bwp}−1)}.

Now BWP_{bw} is computed as,

BWP_{bw}=S₁+S₂

Here S₂ is considered to be an optional parameter. If the BWP_{bw} is always considered to be a multiple of RBG_{bwp}, then S₂=0 and need not be signaled. In that case,

BWP_{bw}=S₁

For S₁ determination, defining RBGₘₐₓ as the RBG size corresponding to the largest BWP in the WB-CC, in terms of BWP_{μ}, S₁ can be determined as shown in the below equation

S₁=min{RBGₘₐₓ*n,S₁_{ₘₐₓ}};
n=0:BMPₘₐₓ
   Here S₁_{ₘₐₓ} is the maximum possible value of S₁. For example, lookup table is generated as shown in a below Table. 1 assuming BMPₘₐₓ=18, S₁_{ₘₐₓ}=272 and possible RBGₘₐₓ sizes as 2,4,8,16,32.

TABLE 1
possible S₁ values
for each RBGₘₐₓ

| RBGₘₐₓ | Set of S₁ values | N^{rbg} |
|---|---|---|
| 2 | 0:2:36 | 19 |
| 4 | 0:4:72 | 19 |
| 8 | 0:8:144 | 19 |
| 16 | 0:16:272 | 19 |
| 32 | 0:32:272 | 10 |

The notion used in Table. 1 for representing the set of S₁ values can be interpreted as {x: y: z} where x is the lower limit and z is the upper limit and y is the step size used.

For S₂ determination, S₂ represents the value of residual RBs added to S₁, to get the final BWP_{bw}. For a given RBG_{bwp}, the possible values of S₂ can be expressed as S₂∈{0: (RBG_{bwp}−1)}. Table 2 shows all possible S₂ values corresponding to each RBG_{bwp}.

TABLE 2
Possible
S2 values

| RBG_{bwp} | S₂ |
|---|---|
| 2 | 0:1 |
| 4 | 0:3 |
| 8 | 0:7 |
| 16 | 0:15 |

For signaling of BWP size, S1 signaling—Without the knowledge of RBG_{bwp} at the UE, signaling of the S₁ can be done either as the number of RBs in the BWP or as the index of the S₁ value in a pre-defined set, when RBG_{bwp} is not known to the UE. If the total possible values of S₁ is N, then the index corresponding to the desired S₁ value can be represented using ┌ log₂(N)┐ bits.

Considering the value of BMPₘₐₓ as 18, all possible S₁ values from Table. 1 can be consolidated as S₁∈{0,2,4,6,8,10,12,14,16,18,20,22,24,26,28,30,32,34,36,40,44,48,52,56,60,64,68,72,80,88,96,104,112,120,128,136,144,160,176,192,208,224,240,256,272}. By using the indexing method, the desired value of S₁ in the above set of size N=46 can be represented using 6 bits instead of using 9 bits to represent values up to 272. Similar set can be formed for any values for the parameters defined and can be indicated using the index from the set.

For S₁ Signaling With the knowledge of RBG_{bwp}. If the UE is informed of the value of RBG_{bwp} in the WB-CC, the possible values of S₁ for the given RBG_{bwp} and S₁_{ₘₐₓ} can be derived directly from the predefined formula,

S₁=min{RBGₘₐₓ*n,S₁_{ₘₐₓ}};
n=0:BMPₘₐₓ
   Which corresponds to a particular row of Table. 1. Thus, indexing can be used only to indicate the S₁ values from the desired row instead of the consolidated set of all possible S₁ values. Now the total number of bits used to indicate S₁ would be ┌ log₂(N^{rbg})┐.

For S₂ signaling without the knowledge of RBG_{bwp}. If RBG_{bwp} is not available to the UE, signaling of S₂ is done as the number of RBs from a pre-defined set. Defining max(RBG_{bwp}) as the maximum value of all possible RBG_{bwp} values, the possible set of values for S₂ can be represented as {0: [max(RBG_{bwp})−1]}. For the given set of RBG_{bwp} values in Table. 2, max(RBG_{bwp})=16 and the possible values of S₂ can be consolidated as,

S₂∈{0,1,2,3,4,5,6,7,8,9,10,11,12,13,14,15}

For S₂ Signaling—With the knowledge of RBG_{bwp}, If the UE is informed of the value of RBG_{bwp}, the possible S₂ values for the given RBG_{bwp} can be derived directly as S₂∈{0: [RBG_{bwp}−1]}. Thus, indexing can be used only to indicate the S₂ value from the desired row instead of the consolidated set of all possible S₂ values. Now the number of bits required to indicate S₂ will be ┌ log₂(RBG_{bwp})┐.

For determining BWP offset, with random values for BWP_{loc}, the BWPs are not properly alignment with each other. This leads to an issue of underutilization of RBGs, due to partially overlapping BWPs. To address this issue, the BWP_{loc} is considered to be a multiple of Gₘₐₓ. This can be expressed as

BWP_{loc}=RBGₘₐₓ*n;
Where n=0: floor(N_{RB}/RBGₘₐₓ)

Here N_{RB} represents the number of RBs in the WB-CC assuming BWP_{μ} as SCS. For example, considering N_{RB}=275, the possible RBGₘₐₓ values are shown in Table. 3,

TABLE 3
Possible BWP offsets

| RBGₘₐₓ | Set of BWP_{loc} | M^{rbg} |
|---|---|---|
| 2 | 0:2:274 | 138 |
| 4 | 0:4:272 | 69 |
| 8 | 0:8:272 | 35 |
| 16 | 0:16:272 | 18 |
| 32 | 0:32:256 | 9 |

For signaling of BWP offset, without the knowledge of RBG_{bwp}, Signaling of the BWP_{loc} can be done either as the number of RBs in the WB-CC or as the index of the BWP_{loc} in a pre-defined set, when RBG_{bwp} is not known to the UE. If there are M possible values for BWP_{loc}, this method requires using ┌ log₂(M)┐ bits to indicate the offset value. Considering the values of RBGₘₐₓ as {2,4,8,16,32}, all possible BWP_{loc} values from Table. 3 can be consolidated as

BWP_{loc}={0,2,4,6,8,10,12,14,16,18,20,22,24,26,28,30,32,34,36,38,40,42,44,46,48,50,52,54,56,58,60,62,64,66,68,70,72,74,76,78,80,82,84,86,88,90,92,94,96,98,100,102,104,106,108,110,112,114,116,118,120,122,124,126,128,130,132,134,136,138,140, 142,144,146,148,150,152,154,156,158,160,162,164,166,168,170,172,174,176,178,180,182,184,186,188,190,192,194,196,198,200,202,204,206,208,210,212,214,216,218,220,222,224,226,228,230,232,234,236,238,240,242,244,246,248,250,252,254,2 56,258,260,262,264,266,268,270,272,274}

By using the indexing method, the value of BWP_{loc} from the above set of size 138 can be represented using 8 bits instead of using 9 bits to represent values up to 272. Similar set can be formed for any values of parameters and can be indicated using the index from the set.

For signaling of BWP offset, with the knowledge of RBG_{bwp}. If the UE is informed of the value of RBG_{bwp}, the possible BWP_{loc} values for the given RBG_{bwp} can be derived directly from the predefined formula,

BWP_{loc}=RBG_{bwp}*n;

Where n=0: floor(N_{RB}/RBG_{bwp}), which corresponds to a particular row of the Table. 3 defined above. Thus, indexing can be used only to indicate the BWP offsets from the desired row instead of the consolidated set of all possible BWP_{loc} values.

For BWP configuration bitmap, without RBG_{bwp}, The BWP bitmap format provided to a user to identify the location and bandwidth of a BWP is a combination of, number of bits required to represent BWP_{loc} and the number of bits required to represent BWP_{bw}. This is indicated in Table. 4.

TABLE 4
BWP configuration

| S₁ | S₂ | BWP_{loc} |
|---|---|---|
| [log₂(N)] | [log₂(max(RBG_{bwp}))] | [log₂(M)] |
| bits | bits | bits |

For the configuration discussed where (RBG_{bwp})=16, N=46 and M=138, the number of bits required to represent BWP size and offset to the UE requires 18 bits.

If there is an implicit mapping between BWP_{bw} value and one of RBG_{bwp} values, then instead of M possibilities for BWP_{loc} there will be only M^{rbg} possibilities. Then the BWP bitmap can be represented as in Table. 5.

TABLE 5
BWP configuration

| S₁ | S₂ | BWP_{loc} |
|---|---|---|
| [log₂(N)] | [log₂ | [log₂(M^{rbg})] |
| bits | bits | bits |

For example, if N=46, max(RBG|bwp)=16, the value of RBG_{bwp}=8 for the given S1 value, and the corresponding M^{rbg}=35, then the number of bits required to represent BWP size and offset to the UE requires 15 bits.

For example, if N=46 and the value of RBG_{bwp}=8 for the given S₁ value, and the corresponding M^{rbg}=35, then the number of bits required to represent BWP size and offset to the UE requires 15 bits.

For with RBG_{bwp}, to avoid the restriction of having a predefined mapping between RBG_{bwp} and S₁ or RBG_{bwp} and BWP_{bw}, RBG_{bwp} can also be signaled to the UE as a part of the BWP configuration. This gives additional flexibility to control RBG size as desired. Given the size of BMP_{bwp} is determined by RBG_{bwp} as ┌ log₂(BWP_{bw}/RBG_{bwp})┐ bits, control over RBG_{bwp} helps in reducing the size of BMP_{bwp}. This in turn helps in reducing the downlink control information (DCI) payload size. Considering the number of possible values for RBG_{bwp} as R, it requires ┌ log₂(R)┐ bits to indicate RBG_{bwp} to the UE. The bitmap for the BWP size and location considering RBG_{bwp} signaled along can be represented as

TABLE 6
BWP configuration

| RBG_{bwp} | S₁ | S₂ | BWP_{loc} |
|---|---|---|---|
| [log₂(R)] | [log₂(N^{rbg})] | [log₂(RBG_{bwp})] | [log₂(M^{rbg})] |
| bits | bits | bits | bits |

For the possible values of RBG_{bwp} as {2,4,8,14,16}, R=4 making the bitfield corresponding to RBG_{bwp} as of length 2 bits. Now, the length of the bitmap configuration for each RBG_{bwp} value is explained in Table. 7.

TABLE 7
Possible BWP bitmap with RBG_{bwp}

| | | | | | Total |
|---|---|---|---|---|---|
| RBG_{bwp} | [log₂(R)] | [log₂(N^{rbg})] | [log₂(RBG_{bwp})] | [log₂(M^{rbg})] | Bits |
| 2 | 2 | 5 | 1 | 8 | 16 |
| 4 | 2 | 5 | 2 | 7 | 16 |
| 8 | 2 | 5 | 3 | 6 | 16 |
| 16 | 2 | 5 | 4 | 5 | 16 |

The main advantage of this method is that the bitmap still requires the same number of bits as in the case of not signaling RBG_{bwp}. Thus, without additional bits, RBG_{bwp} is signaled to the UE and this provides full flexibility in deciding RBG_{bwp} for the given BWP and helps in reducing DCI payload size when required. For all the cases considered above, if BW P_{bw}=S₁, then the bits corresponding to S₂ need not be signaled.

In another embodiment, the UE informs the BS about its capability to receive RBG_{bwp},S₁,S₂ and Offset as a 16 bit IE, at time of association or RRC reconfiguration.

In another embodiment, the capability for enhanced BWP signaling is indicated by the BS to the UE and vice-versa using non-critical extension bits to ensure backward and/or forward compatibility with 3GPP BS or UE.

FIG. 1C illustrates a block diagram of a base station 100 for managing interference in an OFDM system, according to an embodiment as disclosed herein. In an embodiment, the base station 100 includes a memory 110, a processor 120, a communicator 130, and a BWP configuration engine 140.

The memory 110 also stores instructions to be executed by the processor 120. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 can be configured to store larger amounts of information than the memory. In certain examples, a non-transitory storage medium may store data that can, over time, change (e.g., in Random Access Memory (RAM) or cache).

The processor 120 communicates with the memory 110, the communicator 130, and the BWP configuration engine 140. In an embodiment, the memory 110 can be an internal storage unit or it can be an external storage unit of the base station 100, a cloud storage, or any other type of external storage.

The processor 120 is configured to execute instructions stored in the memory 110 and to perform various processes. The communicator 130 is configured for communicating internally between internal hardware components and with external devices via one or more networks.

In an embodiment, the BWP configuration engine 140 is configured to determine a SCS of a BWP, a size of the BWP, and a location of the BWP. Further, the BWP configuration engine 140 is configured to generate a BWP configuration comprising the SCS of the BWP, the size the BWP, and the location of the BWP. Further, the BWP configuration engine 140 is configured to indicate the BWP configuration to a User Equipment.

In an embodiment, the BWP configuration engine 140 is configured to determine a bitmap for the BWP configuration to identify the location of the BWP and a size of the BWP, and wherein a size of the bitmap is a combination of a number of bits required to represent the location of the BWP and a number of bits required to represent the size of the BWP. Further, the BWP configuration engine 140 is configured to indicate the bitmap to the UE.

In an embodiment, the BWP configuration engine 140 is configured to determine a bitmap for the BWP configuration to identify a RBG, the location of the BWP and a size of the BWP, wherein a size of the bitmap is a combination of a number of bits required to represent the RBG and the number of bits required to represent the location of the BWP and a number of bits required to represent the size of the BWP. Further, the BWP configuration engine 140 is configured to indicate the bitmap to the UE.

Although the FIG. 1C shows various hardware components of the base station 100 but it is to be understood that other embodiments are not limited thereon. In other embodiments, the base station 100 may include less or more number of components. Further, the labels or names of the components are used only for illustrative purpose and does not limit the scope of the invention. One or more components can be combined together to perform same or substantially similar function to manage interference in an OFDM system.

FIG. 1D is a flow diagram S100 illustrating a method for managing interference in an OFDM system, according to an embodiment as disclosed herein. The operations (S102-S110a & S110b) are performed by the BWP configuration engine 140.

At S102, the method includes determining a SCS of a BWP, a size of the BWP, and a location of the BWP. At S104, the method includes generating a BWP configuration comprising the SCS of the BWP, the size the BWP, and the location of the BWP. At S106, the method includes indicating the BWP configuration to a User Equipment. At S108a, the method includes determining a bitmap for the BWP configuration to identify the location of the BWP and a size of the BWP, and wherein a size of the bitmap is a combination of a number of bits required to represent the location of the BWP and a number of bits required to represent the size of the BWP.

At S108b, the method includes determining a bitmap for the BWP configuration to identify a RBG, the location of the BWP and a size of the BWP, wherein a size of the bitmap is a combination of a number of bits required to represent the RBG and the number of bits required to represent the location of the BWP and a number of bits required to represent the size of the BWP. At S110a &S110b, the method includes indicating the bitmap to the UE.

FIG. 1E is a flow diagram S102a illustrating a method for defining the size of the BWP, according to an embodiment as disclosed herein. The operations (S102aa-S102ad) are performed by the BWP configuration engine 140.

At S102aa, the method includes determining whether the size of the BWP is a multiple of a RBG from a set of RBGs. At S102ab, the method includes checking the size of the BWP multiple of the RBG. At S102ac, the method includes defining the size of the BWP comprises of the first signal and the second signal when the size of the BWP does not have to be the multiple of the RBG from the set of RBGs. At S102ad, the method includes defining the size of the BWP comprises of the first signal when the size of the BWP does not have to be the multiple of the RBG from the set of RBGs.

FIG. 1F is a flow diagram S102b illustrating a method for the location of the BWP is indicated to the UE, according to an embodiment as disclosed herein. The operations (S102ba-S102bd) are performed by the BWP configuration engine 140.

At S102ba, the method includes determining whether the RBG for the BWP information is known or not known to the UE in the WB-CC. At S102bb, the method includes checking RBG for the BWP information. At S102bc, the method includes indicating the location of the BWP to the UE as the number of RBs in the WB-CC or as an index of a pre-defined set comprising all possible values of location of the BWP, when the RBG for the BWP information is not known to the UE in the WB-CC. At S102bd, the method includes indicating an index of a pre-defined set of location of the BWP to be derived by the UE, when the RBG for the BWP information is known to the UE in the WB-CC.

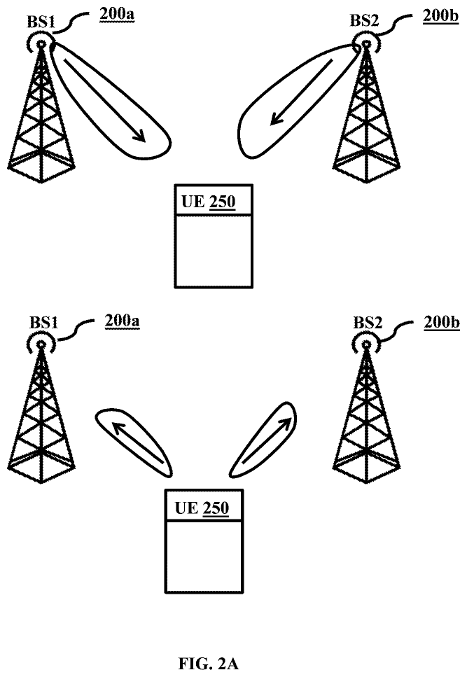

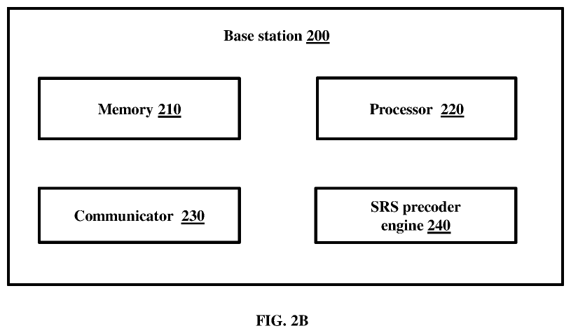

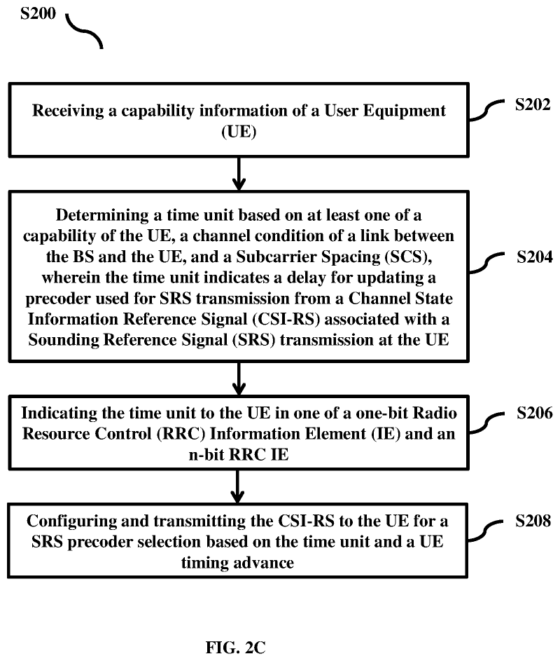

FIG. 2A is an illustration of CSI-RS aided precoded SRS transmission, according to embodiments as disclosed herein.

In a beam based operation, the performance of the MIMO system depends on the CSI at the transmitter (CSIT). In downlink transmission, where base station (BS) 200 is a transmitter and the user equipment (UE) 250 is a receiver, the BS 200 transmits a reference signal to measure a downlink CSI at the UE 250. In uplink transmission, where the UE 250 is the transmitter and the BS 200 is the receiver, the UE 250 transmits a reference signal to measure an uplink CSI at the BS 200. In 4G and 5G standards, the downlink reference signal is called as CSI-RS and uplink reference signal is called as SRS.

Transmit beamforming is done by precoding the transmit signals based on the CSI to direct the transmitted energy towards the receiver using multiple transmit antennas. Receive beamforming can be achieved by appropriately combining the received signals from the multiple receive antennas. To meet 5G data rate requirements, it is essential to use mmWave band which offers more bandwidth. Transmit and receive beamforming techniques are the key enablers for the mmWave communication to compensate its poor channel characteristics. Due to smaller wavelengths in mmWave communication, the antenna size will be smaller and hence packing more number of antennas in the UE 250 is not difficult without affecting its device form factor. With more number of antennas at the BS 200 and UE 250, highly directive transmission and reception can be achieved using the electronically steerable beams.

Multiple transmit and receive beams at the BS 200 and UE 250 are necessary to achieve a reliable communication especially in the mmWave channel. To maintain the best transmit beam and receive beam pair link, beam management procedure is defined in the 5G standard. The BS 200 can be considered as multiple transmit-receive point (TRP) located at different locations to ensure more reliable and coverage concerns. The UE 250 can transmit and receive through different beam pair links associated with one or more TRPs.

In an embodiment, beam correspondence, the concept of beam correspondence works based on channel reciprocity. Considering the uplink channel characteristics is very similar to the corresponding downlink channel, the receive beam selected by the UE 250 in downlink can act as the best transmit beam in uplink. This is true for both time division multiplexing and frequency division multiplexing. In NR, this beam correspondence is mainly used to assist in the beam management procedures. The followings are defined as Transmitter/Receiver beam correspondence at TRP and UE 250:
a. Tx/Rx beam correspondence at TRP holds if at least one of the following is satisfied:
   i. TRP can determine a TRP Rx beam for the uplink reception based on UE's 250 downlink measurement on TRP's one or more Tx beams.
   ii. TRP can determine a TRP Tx beam for the downlink transmission based on TRP's uplink measurement on TRP's one or more Rx beams
b. Tx/Rx beam correspondence at UE 250 holds if at least one of the following is satisfied:
   i. The UE 250 can determine a UE 250 Tx beam for the uplink transmission based on UE's downlink measurement on UE's 250 one or more Rx beams.
   ii. The UE 250 can determine a UE 250 Rx beam for the downlink reception based on TRP's indication based on uplink measurement on UE's 250 one or more Tx beams

In an embodiment, SRS Precoder selection, in downlink, one or more beams are transmitted from BS using the one or more CSI-RS resources. UE receives the CSI-RS, measures the quality of one or more beams and reports the CSI for each beam to the BS using the uplink control channel.

In uplink, there can be multiple TRPs which can receive SRS signal from the UE 250. The signal quality at each TRP can be different and it is depending on the transmit beamforming used by the UE 250. For non-codebook based uplink transmission, the UE 250 determines the precoder for beamforming its data channel transmission by using downlink reference signal like CSI-RS. In this case, CSI-RS is configured by TRP at appropriate time before UL transmission is scheduled. Precoder will be calculated on one or more CSI-RS resources from one or more TRPs.

These precoders can be applied on uplink SRS and transmitted to respective TRPs in uplink. The TRPs receive the SRS from the UE 250 and BS 200 measures the quality of SRS to decide on best beam in terms of an identifier namely SRS resource indicator (SRI) and, modulation and coding scheme (MCS). Then the selected SRI and MCS are signaled to UE 250 via the control channel. This process is illustrated in FIG. 2A. At time t1 the UE 250 receives CSI-RS from BS1 200a and BS2 200b. The UE 250 calculates UL precoder for BS1 200a and BS2 200b by using respective CSI-RS. At time t2 UE transmits precoded SRS to BS1 200a and BS2 200b.

The BS 200 configures one or more CSI-RS linked with SRS through semi static higher layer signaling, for e.g., Radio Resource Control(RRC) signaling. Different UEs can have different processing capabilities and it is assumed that each UE 250 has conveyed its capability through capability signaling mechanism. Accordingly, the BS 200 should configure downlink CSI-RS well in advance than uplink SRS transmission considering the CSI-RS processing time for calculation of precoder, SRS preparation time and timing advancement.

In Fast SRS precoder update, the UE 250 can update the uplink SRS precoder from the best receive precoder measured using the downlink CSI-RS. The delay between the CSI-RS reception and the SRS transmission should be minimum to achieve a more reliable link adaptation which results a better performance. The delay t_{d} is defined using any one of the following equations

t_{d}=(4·2^{μ}−μ+K_{offset})(T_{sym}^{μ}) (1)

t_{d}=(4·2^{μ}−2μ+K_{offset})(T_{sym}^{μ}) (2)

t_{d}=(3·2^{μ}+┌(1−μ/3)┐+K_{offset})(T_{sym}^{μ}) (3)

where μ is a numerology factor given by

$$l o {g}_{2} ( \frac{Δ f}{Δ {f}_{ref}} ) ,$$

Δf is subcarrier spacing in Hz, and Δf_{ref} is reference subcarrier spacing in Hz, T_{sym}^{μ} is OFDM symbol duration for a given μ, K_{offset} is an offset in terms of number of OFDM symbols. For e.g., Δf_{ref}=15 KHz and μ can be any one value from the set {0, 1, 2, 3, 4, 5}. K_{offset} is UE 250 dependent parameter. Low-capable UE has larger K_{offset} than that of high-capable UE 250. Moreover, K_{offset} can be selected based on channel variations.

In RRC signaling of the delay t_{d}, the minimum delay parameter is informed by the BS 200 to the UE 250 using UE 250-specific RRC signaling. The RRC signaling can be done in any one of the following methods:

Method 1: One-bit RRC Information Element (IE): The RRC IE, for e.g., SRS-Precoding Delay is the minimum delay parameter given to the UE as per the Abstract Syntax Notation (ASN). 1 format shown below.

SRS-PrecodingDelay:=BOOLEAN OPTIONAL

OR

SRS-PrecodingDelay:=INTEGER(0 . . . 1) OPTIONAL

The one bit denotes whether UE will compute the delay value using one of the t_{d} equations (1), (2), and (3) or consider the default value of t_{d}. For e.g., bit ‘0’ denotes that the UE should consider the default value of t_{d} and bit ‘1’ represents that the UE should use one of the t_{d} equations (1), (2), and (3) to obtain the minimum delay value depending upon its μ and assuming K_{offset}=0. Further, the RRC IE is an optional parameter and absence of this IE will denote that the UE should use the default value of t_{d}. For e.g., default t_{d}=42. T_{sym}^{μ}.

Method 2: n bits RRC IE: In this case, the RRC IE comprises n bits as the ASN format shown below.

SRS-Preparation Delay::=INTEGER(0 . . . 2ⁿ−1) OPTIONAL
Integers 0, 1, . . . , 2n−1 represent the indices of the look-up table of K_{offset}. For example. The look-up table n=2 is shown in Table. 8.

TABLE 8
Look-up table for K_{offset}

| SRS- | |
|---|---|
| Preparation | |
| Delay | K_{offset} |
| 0 | 0 |
| 1 | 2 |
| 2 | 4 |
| 3 | 8 |

In this case as well, the RRC IE is an optional parameter and absence of this IE will denote that the UE should use the default value of t_{d}. For e.g., default t_{d}=42·T_{sym}^{μ}.

In another embodiment, the capability of enhancement to SRS precoder updating with channel dependent delay between an SRS transmission and the last received aperiodic CSI-RS will be indicated by the BS to the UE and vice-versa using non-critical extension bits to ensure backward and/or forward compatibility with 3GPP BS or UE.

In another embodiment, signaling for the actual delay will be indicated by the BS to the UE using non-critical extension bit to ensure backward and/or forward compatibility with 3GPP BS or UE.

FIG. 2B illustrates a block diagram of the base station 200 for optimizing a CSI acquisition in an OFDM system, according to embodiments as disclosed herein. In an embodiment, the base station 200 includes a memory 210, a processor 220, a communicator 230, and a SRS precoder engine 240.

The memory 210 also stores instructions to be executed by the processor 220. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In some examples, the memory 210 can be configured to store larger amounts of information than the memory. In certain examples, a non-transitory storage medium may store data that can, over time, change (e.g., in Random Access Memory (RAM) or cache).

The processor 220 communicates with the memory 210, the communicator 230, and the SRS precoder engine 240. In an embodiment, the memory 210 can be an internal storage unit or it can be an external storage unit of the base station 200, a cloud storage, or any other type of external storage.

The processor 220 is configured to execute instructions stored in the memory 210 and to perform various processes. The communicator 230 is configured for communicating internally between internal hardware components and with external devices via one or more networks.

In an embodiment, the SRS precoder engine 240 is configured to receive a capability information of the User Equipment (UE) 250. Further, the SRS precoder engine 240 is configured to determine a time unit based on at least one of a capability of the UE 250, a channel condition of a link between the BS 200 and the UE 250, and a SCS, wherein the time unit indicates a delay for updating a precoder used for SRS transmission from a CSI-RS associated with a SRS transmission at the UE 250. Further, the SRS precoder engine 240 is configured to indicate the time unit to the UE 250. Further, the SRS precoder engine 240 is configured to configure and transmit the CSI-RS to the UE 250 for a SRS precoder selection based on the time unit and a UE timing advance.

Although the FIG. 2B shows various hardware components of the base station 100 but it is to be understood that other embodiments are not limited thereon. In other embodiments, the base station 100 may include less or more number of components. Further, the labels or names of the components are used only for illustrative purpose and does not limit the scope of the invention. One or more components can be combined together to perform same or substantially similar function to optimize a CSI acquisition in an OFDM system.

FIG. 2C is a flow diagram S200 illustrating a method for optimizing a CSI acquisition in an OFDM system, according to embodiments as disclosed herein. The operations (S202-S208) are performed by the SRS precoder engine 240.

At S202, the method include receiving a capability information of a User Equipment (UE) 250. At S204, the method include determining a time unit based on at least one of a capability of the UE 250, a channel condition of a link between the BS 200 and the UE 250, and a SCS, wherein the time unit indicates a delay for updating a precoder used for SRS transmission from a CSI-RS associated with a SRS transmission at the UE 250. At S206, the method include indicating the time unit to the UE 250. At S208, the method include configuring and transmitting the CSI-RS to the UE 250 for a SRS precoder selection based on the time unit and a UE timing advance.

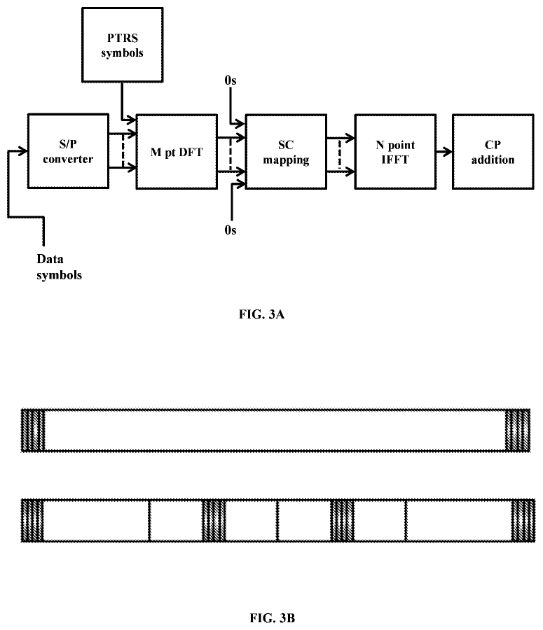

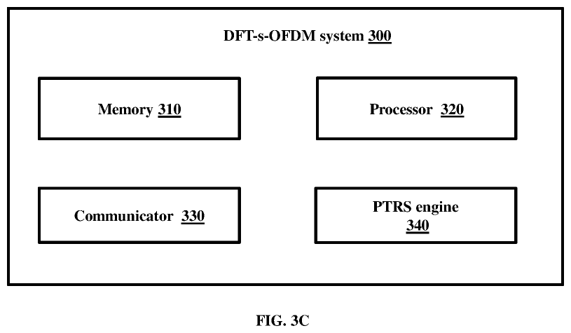

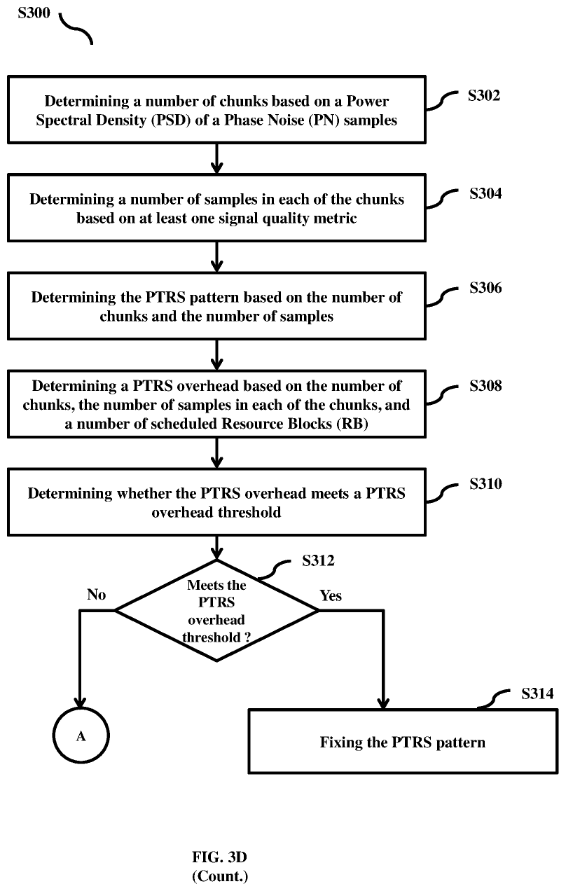

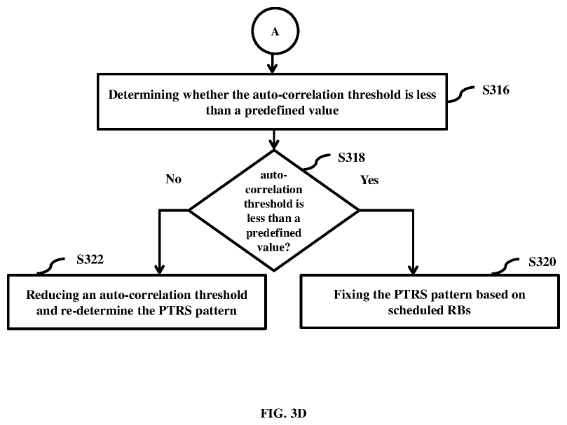

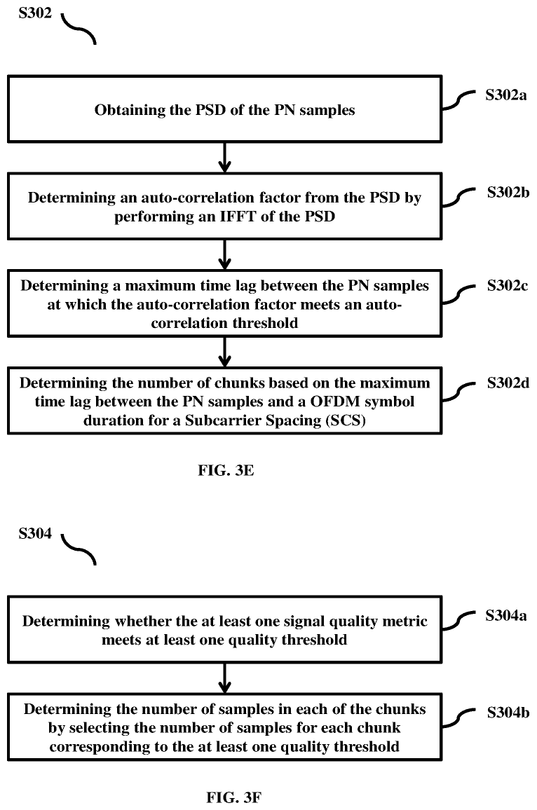

FIG. 3A is a block diagram of DFT-s-OFDM system with pre-DFT PTRS insertion, according to embodiments as disclosed herein.

In PTRS in mmWave band, migrating to mmwave band poses several challenges due to high carrier frequencies. One such challenge is impairment caused by PN. Phase noise is caused by abnormalities in the Local Oscillator (LO) in UE and/or eNB. Presence of phase modulated components in LO output leads to phase noise. In an OFDM system, phase noise causes two effects: 1. Common Phase Error (CPE) and 2. Inter Carrier Interference (ICI). CPE causes rotation of the constellation points, whereas ICI leads to smearing of the points, decreasing the effective SNR. In order to mitigate the effects of phase noise, a dedicated Reference Signal (RS) called Phase Tracking Reference Signal (PTRS) is introduced in NR. Since PN variations are more rapid from symbol to symbol, it is preferred to have PTRS in every OFDM symbol or every other OFDM symbol.

In PTRS for DFT-S-OFDM, DFT-s-OFDM is supported in the uplink of the NR physical layer. This is introduced to reduce PAPR effects, especially for the cell edge users. Usage of PTRS has been supported for DFT-s-OFDM also. In case of DFT-s-OFDM, PTRS symbols are inserted in time domain, i.e., before DFT. This ensures lower PAPR value, even after PTRS insertion. Block diagram of a typical DFT-s-OFDM system (depicting pre-DFT PTRS insertion) is shown in FIG. 3A.

A chunk type of PTRS pattern is used in DFT-s-OFDM systems, where multiple chunks are placed in a pre-DFT OFDM symbol with multiple samples in a chunk. Chunk pattern forms a tradeoff between a fully localized and a fully distributed pattern. Multiple chunks enable effective interpolation of PN values across the OFDM symbol, while multiple samples in a chunk enable noise averaging of estimated phase values within a chunk. Number of chunks in an OFDM symbol is denoted by ‘X’ and number of samples inside the chunk is denoted by ‘K’. Supported values for X={2,4,8} and supported values for K={2,4}.

FIG. 3B is an illustration of sample PTRS chunk patterns, according to embodiments as disclosed herein. As shown in the FIG. 3B, two example chunk patterns, one with 2 chunks and 4 samples per chunk (X=2; K=4), second with 4 chunks and 4 symbols per chunk (X=4; K=4).

The chunk pattern, i.e., values of X and K are decided based on the scheduled number of RBs (N_{RB}) as shown in following Table. 9.

TABLE 9
Chunk pattern

| Scheduled BW | X × K |
|---|---|
| N_{RB0}N_{RB} ≤ N_{RB1} | 2 × 2 |
| N_{RB1}N_{RB} ≤ N_{RB2} | 2 × 4 |
| N_{RB2}N_{RB} ≤ N_{RB3} | 4 × 2 |
| N_{RB3}N_{RB} ≤ N_{RB4} | 4 × 4 |
| N_{RB4} < N_{RB} | 8 × 4 |

The aim of this proposal is to determine the suitable values of N_{RBi} (i=0, 1, 2, 3, 4).

The values of N_{RBi} (i=0, 1, 2, 3, 4) is generally signaled from the gNB to UE through RRC. The values of scheduled bandwidth can range from 0 to 275. This requires 9 bits of signaling per NRB. Since there are totally 5 NRB values, a total of 45 bits of signaling are required. This signaling overhead can be reduced if a default table is specified (known to both gNB and UE). The aim of this proposal is to determine the suitable values of NRBi (i=0, 1, 2, 3, 4).

However, it should be noted that the presence of NRBi values in RRC will override the default table. Also, the UE should indicate to the gNB, the availability of default table of thresholds on scheduled bandwidth for PTRS chunk pattern selection, in case of UL with transform precoding, during the initial association process.

In chunk pattern design for DFT-s-OFDM, factors impacting PTRS chunk pattern is given below,
1. PSD of PN model: PN with wider PSD mean less correlation between PN samples in time domain. This necessitates frequent chunks across OFDM symbol.
2. SINR/CQI/MCS: Phase estimates at PTRS points are more erroneous at lower SINR. Averaging within a chunk helps in reducing the error. Therefore, larger chunk size is required at low SINR Channel Quality Indicator (CQI) is calculated based on SINR. The MCS chosen for transmission is based on CQI. SINR, CQI and MCS are linked with one another. Therefore, chunk size is based on SINR/CQI/MCS (whichever applicable).
3. Permitted overhead: Frequent pattern and/or wide chunks mean higher overhead. Percentage overhead is based on Number of scheduled RBs.

In an embodiment, chunk pattern design procedure, the PSD values of one PN model is taken from the existing system. PSD is the Fourier transform of auto correlation. Taking IFFT of PSD, yields the autocorrelation values of the phase noise process. Autocorrelation is usually plotted against a parameter called “lag”, the distance between samples. Autocorrelation value for lag “r” represents the level of similarity between values that are separated by “r” seconds. A wider autocorrelation means that samples that are even widely spaced are similar. On the other hand, a narrow auto correlation means that even samples that are close apart tend to be dissimilar.

A threshold for autocorrelation is fixed. The lag value “τ” for which the autocorrelation exceeds the threshold is found out. Let the value be “τ_0”. This means that the samples get dissimilar only after lag, “τ_0”. Therefore, it is sufficient to place PTRS chunks separated by “τ_0”. Let the total OFDM symbol duration is “T”. The number of PTRS chunks required in one OFDM symbol is given by Number of chunks=T/τ_0. The procedure to find the number of chunks is described in FIG. 3D. However, the maximum PTRS chunks possible in one OFDM symbol is 8. Therefore, if Number of chunks exceeds 8, it is restricted to be 8.

The samples in a PTRS chunk are decided based on SINR/CQI/MCS. In case SINR is used: for SINR≥10 dB, number of sample in a chunk=2, otherwise number of sample in a chunk=4. In case CQI is used: for CQI≥10, number of sample in a chunk=2, otherwise number of sample in a chunk=4. In case MCS is used: for MCS≥10, number of sample in a chunk=2, otherwise number of sample in a chunk=4. SINR of 10 dB corresponds to CQI index of 10 (for BLER<0.1), which corresponds to 64QAM modulation.

The PTRS overhead in one OFDM symbol is calculated as % PTRS OH=(Number of PTRS chunks×number of samples in chunk)/(Number of scheduled RB×12). If the percentage overhead is greater than 8.3%, then reduce the threshold for autocorrelation and repeat the process. The overhead of 8.33% is chosen as the threshold, since one PTRS symbol per RB is the maximum PTRS density supported for CP-OFDM.

If the percentage overhead is higher even after reducing the threshold, find the maximum chunk pattern that will yield the required overhead for the scheduled number of RBs. The process is also repeated for various PN models and the threshold values of scheduled RBs are decided. The overall process is depicted in flowchart in FIG. 3D.

The threshold values of scheduled RBs are as given in following tables. There are two sets of threshold values: config0 and config1. Config0 is used for SINR<10 dB/CQI<10/MCS<10, while Config1 is used for SINR≥10 dB/CQI>10/MCS>10.

In an embodiment, Case I: (8×4) pattern is supported

TABLE 10
Chunk pattern: Config 0
(with (8 × 4) pattern)

| Scheduled BW | X × K |
|---|---|
| 0 < N_{RB} ≤ 8 | 2 × 2 |
| 8 < N_{RB} ≤ 24 | 2 × 4 |
| 24 < N_{RB} ≤ 96 | 4 × 4 |
| 96 < N_{RB} | 8 × 4 |

TABLE 11
Chunk pattern: Config 1
(with (8 × 4) pattern)

| Scheduled BW | X × K |
|---|---|
| 0 < N_{RB} ≤ 24 | 2 × 2 |
| 24 < N_{RB} ≤ 96 | 4 × 2 |
| 96 < N_{RB} | 8 × 4 |

In an embodiment, Comparing with Table. 9, the threshold values of scheduled bandwidth are,

TABLE 12
Threshold values of scheduled
BW (NRBi, i = 0, 1, 2, 3, 4)

| Config0 | Config1 |
|---|---|
| N_{RB0} = 0 | N_{RB0} = 0 |
| N_{RB1} = 8 | N_{RB1} = N_{RB2} = 24 |
| N_{RB2} = N_{RB3} = 24 | N_{RB3} = N_{RB4} = 96 |
| N_{RB4} = 96 | |

In an embodiment, Case II: (8×4) pattern is not supported

TABLE 13
Chunk pattern: Config0
(without (8 × 4) pattern)

| Scheduled BW | X × K |
|---|---|
| 0 < N_{RB} ≤ 8 | 2 × 2 |
| 8 < N_{RB} ≤ 24 | 2 × 4 |
| 24 < N_{RB} | 4 × 4 |

TABLE 14
Chunk pattern: Config1
(without (8 × 4) pattern)

| Scheduled BW | X × K |
|---|---|
| 0 < N_{RB} ≤ 24 | 2 × 2 |
| 24 < N_{RB} | 4 × 2 |

In an embodiment, Comparing with Table. 9, the threshold values of scheduled bandwidth are,

TABLE 15
Threshold values of scheduled
BW (N_{RBi}, i = 0, 1, 2, 3, 4, 5)

| Config0 | Config1 |
|---|---|
| N_{RB0} = 0 | N_{RB0} = 0 |
| N_{RB1} = 8 | N_{RB1} = N_{RB2} = 24 |
| N_{RB2} = N_{RB3} = 24 | |

In an embodiment, proposal on constraints on bandwidth threshold values for dynamic signaling, the bandwidth threshold values, i.e., N_{RBi}, can be fixed or dynamic Dynamic signaling of N_{RBi} values can be through RRC. There is also a discussion on whether to send the differential values (N_{RBi}−N_{RBi-1}), in order to reduce signaling overhead. In such a case, it is suggested to frame the threshold values to follow a pattern, without affecting the overhead or performance constraints. From Table. 12 and Error! Reference source not found.15, it can be seen that the threshold values are multiples of 8. Therefore, the differential values are also multiples of 8. In this pattern, it is sufficient to signal the multiplicative factor of the difference, i.e., for (N_{RB1}−N_{RB2}=8), the RRC parameter can be set as ‘1’, indicating the difference to be (‘1’×8). This helps in reducing the bit width requirement.

In another embodiment, capability to use PTRS density table will be indicated by the BS to the UE and vice-versa using non-critical extension bits to ensure backward and/or forward compatibility with 3GPP BS or UE.

In another embodiment, capability to choose the PTRS chunk patterns based on SINR is indicated by the BS to the UE and vice-versa using non-critical extension bits to ensure backward and/or forward compatibility with 3GPP BS or UE.

In another embodiment, differential value of threshold values of scheduled resources are indicated to save bits, if RRC signaling is used to indicate the threshold values of scheduled resources. It will be indicated by the BS to the UE and vice-versa using non-critical extension bits to ensure backward and/or forward compatibility with 3GPP BS or UE.

In another embodiment, the capability for at least one of enhanced BWP signaling, enhancement to SRS precoder updating and usage of PTRS density table will be indicated by the BS to the UE and vice-versa using non-critical extension bits to ensure backward and/or forward compatibility with 3GPP BS or UE.

FIG. 3C illustrates a block diagram of (DFT-s-OFDM) system for determining a PTRS pattern, according to embodiments as disclosed herein. In an embodiment, the DFT-s-OFDM system 300 includes a memory 310, a processor 320, a communicator 330, and a PTRS engine 340.

The memory 310 also stores instructions to be executed by the processor 320. The memory 310 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 310 may, in some examples, be considered a non-transitory storage medium. The term “non-transitory” may indicate that the storage medium is not embodied in a carrier wave or a propagated signal. However, the term “non-transitory” should not be interpreted that the memory 310 is non-movable. In some examples, the memory 310 can be configured to store larger amounts of information than the memory. In certain examples, a non-transitory storage medium may store data that can, over time, change (e.g., in Random Access Memory (RAM) or cache).

The processor 320 communicates with the memory 310, the communicator 330, and the PTRS engine 340. In an embodiment, the memory 310 can be an internal storage unit or it can be an external storage unit of the DFT-s-OFDM system 300, a cloud storage, or any other type of external storage.

The processor 320 is configured to execute instructions stored in the memory 310 and to perform various processes. The communicator 330 is configured for communicating internally between internal hardware components and with external devices via one or more networks.

In an embodiment, the PTRS engine 340 is configured to determine a number of chunks based on a PSD of a PN samples. Further, the PTRS engine 340 is configured to determine a number of samples in each of the chunks based on at least one signal quality metric. Further, the PTRS engine 340 is configured to determine the PTRS pattern based on the number of chunks and the number of samples. Further, the PTRS engine 340 is configured to determine a PTRS overhead based on the number of chunks, the number of samples in each of the chunks, and a number of scheduled Resource Blocks (RB). Further, the PTRS engine 340 is configured to determine whether the PTRS overhead meets a PTRS overhead threshold. Further, the PTRS engine 340 is configured to perform either fix the PTRS pattern when the PTRS overhead meets the PTRS overhead threshold or reduce an auto-correlation threshold when the PTRS overhead does not meet the PTRS overhead threshold.

Although the FIG. 3C shows various hardware components of the DFT-s-OFDM system 300 but it is to be understood that other embodiments are not limited thereon. In other embodiments, the DFT-s-OFDM system 300 may include less or more number of components. Further, the labels or names of the components are used only for illustrative purpose and does not limit the scope of the invention. One or more components can be combined together to perform same or substantially similar function to determine a PTRS pattern in DFT-s-OFDM system.

FIG. 3D is a flow diagram S300 illustrating a method for determining a PTRS pattern in DFT-s-OFDM system, according to embodiments as disclosed herein. The operations (S302-S322) are performed by the DFT-s-OFDM system 300.

At S302, the method includes determining a number of chunks based on a PSD of a PN samples. At S304, the method includes determining a number of samples in each of the chunks based on at least one signal quality metric. At S306, the method includes determining the PTRS pattern based on the number of chunks and the number of samples. At S308, the method includes determining a PTRS overhead based on the number of chunks, the number of samples in each of the chunks, and a number of scheduled Resource Blocks (RB). At S310, the method includes determining whether the PTRS overhead meets a PTRS overhead threshold. At S312, the method includes checking PTRS overhead threshold. At S314, the method includes fixing the PTRS pattern when the PTRS overhead meets the PTRS overhead threshold.

At S316, the method includes determining whether the auto-correlation threshold is less than a predefined value. At S318, the method includes checking auto-correlation threshold is less than a predefined value. At S320, the method includes fixing the PTRS pattern based on scheduled RBs when the auto-correlation threshold is less than a predefined value. At S322, the method includes reducing the auto-correlation threshold and re-determine the PTRS pattern when the auto-correlation threshold is not less than the predefined value.

FIG. 3E is a flow diagram S302 illustrating a method for determining the number of chunks based on the PSD of the PN samples, according to embodiments as disclosed herein. The operations (S302a-S302d) are performed by the DFT-s-OFDM system 300.

At S302a, the method includes obtaining the PSD of the PN samples. At S302b, the method includes determining an auto-correlation factor from the PSD by performing an IFFT of the PSD. At S302c, the method includes determining a maximum time lag between the PN samples at which the auto-correlation factor meets an auto-correlation threshold. At S302d, the method includes determining the number of chunks based on the maximum time lag between the PN samples and a OFDM symbol duration for a SCS.

FIG. 3F is a flow diagram S304 illustrating a method for determining the number of samples in each of the chunks based on one of the SINR, the CQI and the MCS, according to embodiments as disclosed herein. The operations (S304a-S304b) are performed by the DFT-s-OFDM system 300.

At S304a, the method includes determining whether the at least one signal quality metric meets at least one quality threshold. At S304b, the method includes determining the number of samples in each of the chunks by selecting the number of samples for each chunk corresponding to the at least one quality threshold.

The embodiments disclosed herein can be implemented through at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for managing interference in an Orthogonal Frequency Division Multiplexing (OFDM) system, comprising:
determining, by a Base Station (BS)(100), a subcarrier spacing (SCS) of a Bandwidth Part (BWP), a size of the BWP, and a location of the BWP;
generating, by the BS (100), a BWP configuration comprising the SCS of the BWP, the size the BWP, and the location of the BWP; and
indicating, by the BS (100), the BWP configuration to a User Equipment (UE).

2. The method of claim 1, wherein BWP configuration is indicated to the UE during an initial access or semi-statically using a higher layer signaling, and wherein the BS indicates the BWP configuration to the UE after receiving capability information from the UE indicating a capability of the UE to receive a type of BWP configuration, and the BS(100) sending to the UE the type of BWP configuration used by RRC signalling.

3. The method of claim 1, wherein the location of the BWP comprises an offset of a starting RB of the BWP with respect to a zeroth RB of a wide band component carrier (WB-CC).

4. The method of claim 1, wherein defining the size of the BWP comprises:
determining whether the size of the BWP is a multiple of a Resource Block Group (RBG) from a set of RBGs; and
performing one of:
defining the size of the BWP comprises of a first signal and a second signal when the size of the BWP does not have to be the multiple of the RBG from the set of RBGs; and
defining the size of the BWP comprises of the first signal when the size of the BWP does not have to be the multiple of the RBG from the set of RBGs.

5. The method of claim 4, wherein the first signal is a multiple of the RBG from the set of RBGs and the second signal is residual RBs in the size of the BWP.

6. The method of claim 4, wherein determining the first signal comprises:
defining a maximum RBG corresponding to a largest BWP in a WB-CC; and
determining the first signal based on a function of the maximum RBG, a maximum bitmap size, and a maximum value for the first signal.

7. The method of claim 4, wherein the first signal is indicated to the UE by:
determining whether the RBG for the BWP is known or not known to the UE in the WB-CC; and
performing one of:
indicating the first signal to the UE as a number of RBs in the BWP or as an index of a pre-defined set comprising all possible values of the first signal, when the RBG for the BWP is not known to the UE in the WB-CC, and
indicating an index of a pre-defined set of values of the first signal to be derived by the UE, when the RBG for the BWP is known to the UE in the WB-CC.

8. The method of claim 4, wherein the second signal are indicated to the UE by:
determining whether the RBG for the BWP information is known or not known to the UE in the WB-CC; and
performing one of:
indicating the second signal to the UE as a number of RBs in the BWP or as an index of a pre-defined set comprising all possible values of the second signal, when the RBG for the BWP information is not known to the UE in the WB-CC, and
indicating an index of a pre-defined set of values of the second signal to be derived by the UE, when the RBG for the BWP information at the UE in the WB-CC.

9. The method of claim 1, wherein the location of the BWP is determined based on a multiple of a maximum RBG corresponding to a largest BWP in a WB-CC.

10. The method of claim 1, wherein the location of the BWP is indicated to the UE by:
determining whether the RBG for the BWP information is known or not known to the UE in the WB-CC; and
performing one of:
indicating the location of the BWP to the UE as the number of RBs in the WB-CC or as an index of a pre-defined set comprising all possible values of location of the BWP, when the RBG for the BWP information is not known to the UE in the WB-CC, and
indicating an index of a pre-defined set of location of the BWP to be derived by the UE, when the RBG for the BWP information is known to the UE in the WB-CC.

11. The method of claim 1, further comprising:
determining a bitmap for the BWP configuration to identify the location of the BWP and a size of the BWP, and wherein a size of the bitmap is a combination of a number of bits required to represent the location of the BWP and a number of bits required to represent the size of the BWP; and
indicating the bitmap to the UE.

12. The method of claim 1, further comprising:
determining a bitmap for the BWP configuration to identify a RBG, the location of the BWP and a size of the BWP, wherein a size of the bitmap is a combination of a number of bits required to represent the RBG and the number of bits required to represent the location of the BWP and a number of bits required to represent the size of the BWP; and
indicating the bitmap to the UE.

13. A method for determining a phase-noise compensation tracking reference signal (PTRS) pattern in discrete Fourier transform spread orthogonal frequency division multiplexing (DFT-s-OFDM) system (300), comprising:
determining, by the DFT-s-OFDM system (300), a number of chunks based on a Power Spectral Density (PSD) of a Phase Noise (PN) samples;
determining, by the DFT-s-OFDM system (300), a number of samples in each of the chunks based on at least one signal quality metric; and
determining, by the DFT-s-OFDM system (300), the PTRS pattern based on the number of chunks and the number of samples.

14. The method of claim 13, wherein determining, by the DFT-s-OFDM system (300), the number of chunks based on the PSD of the PN samples comprising:
obtaining the PSD of the PN samples;
determining an auto-correlation factor from the PSD by performing an IFFT of the PSD;
determining a maximum time lag between the PN samples at which the auto-correlation factor meets an auto-correlation threshold; and
determining the number of chunks based on the maximum time lag between the PN samples and a OFDM symbol duration for a SCS.

15. The method of claim 13, wherein determining, by the DFT-s-OFDM system (300), the number of samples in each of the chunks based on one of the signal-to-interference-plus-noise ratio (SINR), the CQI and the MCS comprising:
determining whether the at least one signal quality metric meets at least one quality threshold; and
determining the number of samples in each of the chunks by selecting the number of samples for each chunk corresponding to the at least one quality threshold.

16. The method of claim 13, wherein further comprising:
determining a PTRS overhead based on the number of chunks, the number of samples in each of the chunks, and a number of scheduled Resource Blocks (RB);
determining whether the PTRS overhead meets a PTRS overhead threshold; and
performing one of:
fixing the PTRS pattern when the PTRS overhead meets the PTRS overhead threshold; and
reducing an auto-correlation threshold when the PTRS overhead does not meet the PTRS overhead threshold.

17. The method of claim 16, wherein reducing an auto-correlation threshold when the PTRS overhead does not meet the PTRS overhead threshold comprising:
determining whether the auto-correlation threshold is less than a predefined value; and
performing one of:
fixing the PTRS pattern based on scheduled RBs when the auto-correlation threshold is less than the predefined value; and
reducing the auto-correlation threshold and re-determine the PTRS pattern when the auto-correlation threshold is not less than the predefined value.

18. The method of claim 13, wherein the signal quality metric is derived based on at least one of a Signal to Interference & Noise Ratio (SINR), a Channel Quality Indicator (CQI), a Reference signal received power (RSRP), a Reference Signal Received Quality (RSRQ) and a Modulation Coding Scheme (MCS).

19. The method claim 13, wherein the BS receives a capability information of UE indicating at least one of:
a presence of a default table of thresholds on the scheduled bandwidth, for the PTRS chunk pattern selection in the DFT-s-OFDM system (300), using non-critical extension bits;
a capability of the UE to switch or use the PTRS chunk pattern selection based on the at least one signal quality metric;
differential value of threshold values of the scheduled bandwidth using non-critical extension bits, when RRC signaling is used to indicate the threshold values of the scheduled bandwidth; and
a capability to use a PTRS density table using non-critical extension bits.

20. The method claim 13, wherein the BS sends a RRC message to UE indicating at least one of:
a presence of a default table of thresholds on scheduled bandwidth, for the PTRS chunk pattern selection in the DFT-s-OFDM system (300), using non-critical extension bits;
a capability of the BS to switch or use the PTRS chunk pattern based on the at least one signal quality metric using non-critical extension bits;
differential value of threshold values of the scheduled bandwidth, when RRC signaling is used to indicate the threshold values of the scheduled bandwidth using non-critical extension bits; and
a capability to use a PTRS density table using non-critical extension bits.

21. A method for optimizing a Channel State Information (CSI) acquisition in an OFDM system, comprising:
receiving, by a Base Station (BS) (200), a capability information of a User Equipment (UE) (250);
determining, by the BS (200), a time unit based on at least one of a capability of the UE (250), a channel condition of a link between the BS (200) and the UE (250), and a SCS, wherein the time unit indicates a delay for updating a precoder used for SRS transmission from a Channel State Information Reference Signal (CSI-RS) associated with a Sounding Reference Signal (SRS) transmission at the UE (250);
indicating, by the BS (200), the time unit to the UE (250) in one of a one-bit Radio Resource Control (RRC) Information Element (IE) and an n-bit RRC IE; and
configuring and transmitting, by the BS (200), the CSI-RS to the UE (250) for a SRS precoder selection based on the time unit and a UE timing advance.

22. The method of claim 21, wherein the n-bit RRC IE comprises the time unit and corresponding offset of a number of OFDM symbols.

23. The method of claim 21, wherein the capability information send by the UE (250) to the BS (200) is one of the one bit IE and the n-bit IE.

24. The method of claim 23, wherein the n-bit IE indicate an offset of number of OFDM symbols corresponding to a minimum time unit required for UE processing.

25. The method of claim 21 wherein the method comprises indicating, by the UE (250) to BS(200), one of a capability of enhancement to the SRS precoder updation with a channel dependent delay between the SRS transmission and the CSI-RS using non-critical extension bit, and an actual delay in signalling using non-critical extension bit.

26. A Base Station (100) for managing interference in an Orthogonal Frequency Division Multiplexing (OFDM) system, comprising:
a memory (110);
a processor (120); and
a BWP configuration engine (140), coupled to the memory (110) and the processor (120), configured to:
determine a subcarrier spacing (SCS) of a Bandwidth Part (BWP), a size of the BWP, and a location of the BWP;
generate a BWP configuration comprising the SCS of the BWP, the size the BWP, and the location of the BWP; and
indicate the BWP configuration to a User Equipment.

27. The Base Station (100) of claim 26, wherein BWP configuration is indicated to the UE during an initial access or semi-statically using a higher layer signaling, and wherein the BS (100) indicates the BWP configuration to the UE after receiving capability information from the UE indicating a capability of the UE to receive a type of BWP configuration, and the BS(100) sending to the UE the type of BWP configuration used by RRC signalling.

28. The Base Station (100) of claim 26, wherein the location of the BWP comprises an offset of a starting RB of the BWP with respect to a zeroth RB of a WB-CC.

29. The Base Station (100) of claim 26, wherein defining the size of the BWP comprises:
determining whether the size of the BWP is a multiple of a Resource Block Group (RBG) from a set of RBGs; and
performing one of:
defining the size of the BWP comprises of the first signal and the second signal when the size of the BWP does not have to be the multiple of the RBG from the set of RBGs; and
defining the size of the BWP comprises of the first signal when the size of the BWP does not have to be the multiple of the RBG from the set of RBGs.

30. The Base Station (100) of claim 29, wherein the first signal is a multiple of the RBG from the set of RBGs and the second signal is residual RBs in the size of the BWP.

31. The Base Station (100) of claim 29, wherein determining the first signal comprises:
defining a maximum RBG corresponding to a largest BWP in a WB-CC; and
determining the first signal based on a function of the maximum RBG, a maximum bitmap size, and a maximum value for the first signal.

32. The Base Station (100) of claim 29, wherein the first signal is indicated to the UE by:
determining whether the RBG for the BWP is known or not known to the UE in the WB-CC; and
performing one of:
indicating the first signal to the UE as a number of RBs in the BWP or as an index of a pre-defined set comprising all possible values of the first signal, when the RBG for the BWP is not known to the UE in the WB-CC, and
indicating an index of a pre-defined set of values of the first signal to be derived by the UE, when the RBG for the BWP is known to the UE in the WB-CC.

33. The Base Station (100) of claim 29, wherein the second signal are indicated to the UE by:
determining whether the RBG for the BWP information is known or not known to the UE in the WB-CC; and
performing one of:
indicating the second signal to the UE as a number of RBs in the BWP or as an index of a pre-defined set comprising all possible values of the second signal, when the RBG for the BWP information is not known to the UE in the WB-CC, and
indicating an index of a pre-defined set of values of the second signal to be derived by the UE, when the RBG for the BWP information at the UE in the WB-CC.

34. The Base Station (100) of claim 26, wherein the location of the BWP is determined based on a multiple of a maximum RBG corresponding to a largest BWP in a WB-CC.

35. The Base Station (100) of claim 26, wherein the location of the BWP is indicated to the UE by:
determining whether the RBG for the BWP information is known or not known to the UE in the WB-CC; and
performing one of:
indicating the location of the BWP to the UE as the number of RBs in the WB-CC or as an index of a pre-defined set comprising all possible values of location of the BWP, when the RBG for the BWP information is not known to the UE in the WB-CC, and
indicating an index of a pre-defined set of location of the BWP to be derived by the UE, when the RBG for the BWP information is known to the UE in the WB-CC.

36. The Base Station (100) of claim 26, further comprising:
determining a bitmap for the BWP configuration to identify the location of the BWP and a size of the BWP, and wherein a size of the bitmap is a combination of a number of bits required to represent the location of the BWP and a number of bits required to represent the size of the BWP; and
indicating the bitmap to the UE.

37. The Base Station (100) of claim 26, further comprising:
determining a bitmap for the BWP configuration to identify a RBG, the location of the BWP and a size of the BWP, wherein a size of the bitmap is a combination of a number of bits required to represent the RBG and the number of bits required to represent the location of the BWP and a number of bits required to represent the size of the BWP; and
indicating the bitmap to the UE.

38. A DFT-s-OFDM system (300) for determining a phase-noise compensation tracking reference signal (PTRS) pattern in discrete Fourier transform spread orthogonal frequency division multiplexing (DFT-s-OFDM) system (300), comprising:
a memory (310);
a processor (320); and
a PTRS engine (340), coupled to the memory (310) and the processor (320), configured to:
determine a number of chunks based on a Power Spectral Density (PSD) of a Phase Noise (PN) samples;
determine a number of samples in each of the chunks based on at least one signal quality metric; and
determine the PTRS pattern based on the number of chunks and the number of samples.

39. The DFT-s-OFDM system (300) of claim 38, wherein determining, by the DFT-s-OFDM system (300), the number of chunks based on the PSD of the PN samples comprising:
obtaining the PSD of the PN samples;
determining an auto-correlation factor from the PSD by performing an IFFT of the PSD;
determining a maximum time lag between the PN samples at which the auto-correlation factor meets an auto-correlation threshold; and
determining the number of chunks based on the maximum time lag between the PN samples and a OFDM symbol duration for a SCS.

40. The DFT-s-OFDM system (300) of claim 38, wherein determining, by the DFT-s-OFDM system (300), the number of samples in each of the chunks based on one of the SINR, the CQI and the MCS comprising:
determining whether the at least one signal quality metric meets at least one quality threshold; and
determining the number of samples in each of the chunks by selecting the number of samples for each chunk corresponding to the at least one quality threshold.

41. The DFT-s-OFDM system (300) of claim 38, wherein further comprising:
determining a PTRS overhead based on the number of chunks, the number of samples in each of the chunks, and a number of scheduled Resource Blocks (RB);
determining whether the PTRS overhead meets a PTRS overhead threshold; and
performing one of:
fixing the PTRS pattern when the PTRS overhead meets the PTRS overhead threshold; and
reducing an auto-correlation threshold when the PTRS overhead does not meet the PTRS overhead threshold.

42. The DFT-s-OFDM system (300) of claim 41, wherein reducing an auto-correlation threshold when the PTRS overhead does not meet the PTRS overhead threshold comprising:
determining whether the auto-correlation threshold is less than a predefined value; and
performing one of:
fixing the PTRS pattern based on scheduled RBs when the auto-correlation threshold is less than the predefined value; and
reducing the auto-correlation threshold and re-determine the PTRS pattern when the auto-correlation threshold is not less than the predefined value.

43. The DFT-s-OFDM system (300) of claim 38, wherein the signal quality metric is derived based on at least one of a Signal to Interference & Noise Ratio (SINR), a Channel Quality Indicator (CQI), a Reference signal received power (RSRP), a Reference Signal Received Quality (RSRQ) and a Modulation Coding Scheme (MCS).

44. The DFT-s-OFDM system (300) of claim 38, wherein the BS receives a capability information of UE indicating at least one of:
a presence of a default table of thresholds on the scheduled bandwidth, for the PTRS chunk pattern selection in the DFT-s-OFDM system, using non-critical extension bits; and
a capability of the UE to switch or use the PTRS chunk pattern selection based on the at least one signal quality metric;
differential value of threshold values of the scheduled bandwidth using non-critical extension bits, when RRC signaling is used to indicate the threshold values of the scheduled bandwidth; and
a capability to use a PTRS density table using non-critical extension bits.

45. The method claim 38, wherein the BS sends a RRC message to UE indicating at least one of:
a presence of a default table of thresholds on scheduled bandwidth, for the PTRS chunk pattern selection in the DFT-s-OFDM system (300), using non-critical extension bits;
a capability of the BS to switch or use the PTRS chunk pattern based on the at least one signal quality metric using non-critical extension bits;
differential value of threshold values of the scheduled bandwidth, when RRC signaling is used to indicate the threshold values of the scheduled bandwidth using non-critical extension bits; and
a capability to use a PTRS density table using non-critical extension bits.

46. A Base Station (200) for optimizing a Channel State Information (CSI) acquisition in an OFDM system, comprising:
a memory (210);
a processor (220); and
a SRS precoder engine (240), coupled to the memory (210) and the processor (220), configured to:
receiving, by a Base Station (BS) (200), a capability information of a User Equipment (UE) (250);
determining, by the BS (200), a time unit based on at least one of a capability of the UE (250), a channel condition of a link between the BS (200) and the UE (250), and a Subcarrier Spacing (SCS), wherein the time unit indicates a delay for updating a precoder used for SRS transmission from a Channel State Information Reference Signal (CSI-RS) associated with a Sounding Reference Signal (SRS) transmission at the UE (250);
indicating, by the BS (200), the time unit to the UE (250) in one of a one-bit Radio Resource Control (RRC) Information Element (IE) and an n-bit RRC IE; and
configuring and transmitting, by the BS (200), the CSI-RS to the UE (250) for a SRS precoder selection based on the time unit and a UE timing advance.

47. The Base Station (200) of claim 46, wherein the n-bit RRC IE comprises the time unit and corresponding offset of a number of OFDM symbols.

48. The Base Station (200) of claim 46, wherein the capability information send by the UE (250) to the BS (200) is one of the one bit IE and the n-bit IE.

49. The Base Station (200) of claim 48, wherein the n-bit IE indicate an offset of number of OFDM symbols corresponding to a minimum time unit required for UE processing.

50. The method of claim 46, wherein the method comprises indicating, by the BS (200), one of a capability of enhancement to the SRS precoder updation with a channel dependent delay between the SRS transmission and the CSI-RS to the UE (250) using non-critical extension bit, and an actual delay in signalling to the UE (250) using non-critical extension bit.
